(19) United States
(12) Patent Application Publication
(10) Pub. No.: US 2021/0176992 A1
(43) Pub. Date: Jun. 17, 2021

(54) FUNGICIDALLY ACTIVE COMBINATION OF A CLONOSTACHYS STRAIN AND AN AZOLE

(71) Applicants: Bayer Aktiengesellschaft, Leverkusen (DE); Danstar Ferment AG, Zug (CH)

(72) Inventor: Peter DAHMEN, Neuss (DE)

(21) Appl. No.: 17/252,452

(22) PCT Filed: Jun. 27, 2019
(86) PCT No.: PCT/EP2019/067131

§ 371 Date: Dec. 15, 2020

(30) Foreign Application Priority Data
Jul. 3, 2018 (EP) 18181336.1

(51) Int. Cl. A01N 43/653; A01N 63/30

(52) U.S. Cl. CPC A01N 43/653; A01N 63/30

(57) ABSTRACT

The present invention relates to a composition comprising a fungicidally active Clonostachys rosea strain and a fungicidally active azole and methods of using this composition for reducing the DON content in cereal grains infected with Fusarium head blight.

The present invention relates to novel combinations comprising the known fungicidally active biological control agent of the species Clonostachys rosea and at least one member of the class of azoles, which are highly suitable e.g. for reducing deoxynivalenol (DON) in cereal grains infected with Fusarium head blight. Moreover, the invention relates to a method for reducing DON in cereal grains infected with Fusarium head blight, to the treatment of seed, for example seed of cereals, and not least to the treated seed itself.

Fusarium head blight (FHB), also known as scab, is a fungal disease of cereals, in particular wheat, barley, oats, rye, triticale and corn. It is caused by several species of Fusarium which infect the heads of the crop, reducing grain yield. The most common fungal species causing FHB are: Fusarium avenaceum (teleomorph: Gibberella avenacea), Fusarium culmorum, Fusarium graminearum (teleomorph: Gibberella zeae), Fusarium poae and Microdochium nivale (teleomorph: Monographella nivalis, formerly Fusarium nivale) of which Fusarium graminearum is considered the most important causal organism.

The disease is often associated with contamination by mycotoxins produced by the fungi. One mycotoxin can be produced by several Fusarium species, and one species can produce several mycotoxins. Fusarium species associated with FHB produce a range of mycotoxins, most prominent deoxynivalenol (DON) produced by F. graminearum and F. culmorum (Snijders, (1990) Neth J. Plant Pathol. 96:187-198; Proctor et al., (1995) MPMI 8:593-601). DON can inhibit amino acid incorporation and protein production in plant tissues (Casale et al., (1988) Phytopathology 78:1673-1677). The infection of seed by F. graminearum reduces seed germination, seedling vigor and plant emergence (Bechtel et al., (1985) Cereal Chem. 62:191-197). Infection of wheat kernels by G. zeae reduces grain yield and affects grain quality (Clear et al., (1990) Can. J. Plant Sci. 70:1057-1069).

DON is also implicated in adversely affecting the growth of mammalian cells (Knasmuller et al. (1997) Mutation Research 391:39-48). F. graminearum has a strong adverse effect on pasta color when Fusarium damaged kernels make up as little as 2% of a lot (Dexter et al., (1997) Cereal Chem. 74:519-525). Additionally, G. zeae infected kernels can contain the estrogenic toxin zearalenone. Grain contaminated with either of these mycotoxins often is downgraded or cannot be sold. Contaminated grain is frequently unsuitable for human consumption and may be refused as feed (Vesonder et al., (1980) Process Biochem. 16:12-15).

Several species of the genus Clonostachys are known to exhibit activity as biological control agents in the plant protection area. Clonostachys rosea f. rosea, also known as Gliocladium roseum, and Clonostachys rosea f. catenulata, also known as Gliocladium catenulata are species of fungi in the family Bionectriaceae. The non-pathogenic and worldwide distributed fungus C. rosea has the ability to act as a saprophyte on a wide range of soils and is even recognized as a mycoparasite in some studies. Indeed, the fungus can be found within the tissues of a diversity of plants in the wild and in almost all species of crop plants. The fungus is common in healthy roots, leaves, stems, flowers, and fruits of plants collected on farms and in nurseries, orchards, vineyards, pastures, gardens, etc.

The antagonist activity of e.g. C. rosea f. catenulatum is of wide spectrum, and the fungus is currently identified as a strong biological control agent against pathogenic fungi or microorganisms affecting the foliage, flowers, fruits and/or roots of plants of varied crops of agronomic and forest importance as, for example, Alternaria, Bipolaris, Botrytis, Cladosporium, Colletotrichum, Didymella, Fusarium, Monilinia, Mycosphaerella, Nectria, Penicillium, Phytophthora, Plasmodiophora, Plicaria, Pyrenochaeta, Pythium, Rhizoctonia, Sclerotinia, Verticillium, Microdochium, Septoria or Tilletia. It is believed that C. rosea f. catenulatum works by suppressing other fungal pathogens by two main mechanisms, competition and parasitism. C. rosea f. catenulata competes with other fungi for nutrients and living space, thereby preventing them from successfully establishing on the plant. Indeed, colonization of the root zone and aerial parts of the plants seem to be a particularly important feature of the ecology of C. rosea f. catenulata. It is also a hyperparasite which secretes enzymes that degrade the cell walls of pathogens and thus, inhibiting the growth of other fungi.

Only few plant protection means are available to fight FHB, some of them are currently under reconsideration by regulatory authorities so that alternative plant protection means capable of controlling FHB and/or the mycotoxins produced by the causative species are urgently needed.

Surprisingly, it has now been found that the compositions according to the present invention while not resulting in a visual difference in appearance of the treated plants as compared to the untreated control plants, do reduce DON content in the grains of such plants, in particular in cereal grains thus making them suitable for further use.

Accordingly, the present invention relates to a composition comprising a fungicidally active Clonostachys rosea strain and a fungicidally active azole.

The species Clonostachys rosea comprises, for example, Clonostachys rosea f. rosea, also known as Gliocladium roseum, and Clonostachys rosea f. catenulatum, also known as Gliocladium catenulatum. Strains of both Clonostachys rosea f. rosea and Clonostachys rosea f. catenulatum have been shown to exhibit fungicidal activity, also against FHB.

Preferably, said fungicidally active C. rosea strain is active against Fusarium head blight.

Any fungicidally active strain of C. rosea may be used in the present invention.

Strains belonging to C. rosea f. rosea are e.g. strain Cr-7 as disclosed in WO2015/035504, strain 88-710 as disclosed in CA2646428, strain ACM941 as disclosed in Xue (Efficacy of Clonostachys rosea strain ACM941 and fungicide seed treatments for controlling the root tot complex of field pea, Can Jour Plant Sci 83(3): 519-524) and strain IK726 (Jensen D F, et al. Development of a biocontrol agent for plant disease control with special emphasis on the near commercial fungal antagonist Clonostachys rosea strain ‘IK726’; Australas Plant Pathol. 2007; 36:95-101).

Strains belonging to C. rosea f. catenulata are preferably used in the present invention. Strains belonging to C. rosea f. catenulata are e.g. strain J1446 as further described below and strain HL-1-1 as disclosed in Sun et al. (A Peripilin Gene from Clonostachys rosea f. catenulata HL-1-1 Is Related to Sclerotial Parasitism, Int Journ Mol Sci 16:5347-5362).

Among the strains of C. rosea f. catenulata, J1446 has been found particularly useful and refers to the fungus strain deposited at the culture collection of the German Collection of Microorganisms and Cell Cultures (Deutsche Sammlung von Mikroorganismen and Zellkulturen). This strain has been deposited on 19 May 1994 according to the Budapest Treaty to the DSM depositary by the accession number DSM 9212. C. rosea f. catenulatum strain J1446 is a naturally occurring, indigenous wild-type fungal strain, initially isolated from Finnish field soil. C. rosea f. catenulata strain J1446 is commercially available under the trademark Prestop® (available from Lallemand).

The listed strains, in particular the term C. rosea f. catenulata strain J1446, also include isolates of said strains or any cells, cultures, spores, and progeny produced from said strains, such as by asexual reproduction.

Suitable fungicidally active azoles are preferably triazoles which inhibit ergosterol biosynthesis of fungal pathogens. Such triazole compounds include azoles selected from the group consisting of bitertanol, bromuconazole, cyproconazole, difenoconazole, diniconazole, enilconazole, epoxiconazole, fluquinconazole, fenbuconazole, flusilazole, flutriafol, hexaconazole, imibenconazole, ipconazole, metconazole, myclobutanil, penconazole, propiconazole, prothioconazole, simeconazole, triadimefon, triadimenol, tebuconazole, tetraconazole, triticonazole, prochloraz, pefurazoate, imazalil, triflumizole, cyazofamid, benomyl, carbendazim, thiabendazole, fuberidazole, ethaboxam, etridiazole and hymexazole.

In a preferred embodiment, the azole is selected from the group consisting of prothioconazole and epoxiconazole. It is most preferred that the azole is prothioconazole.

As apparent from the enclosed examples, application of the above composition results in DON reduction of about 60%, whereas application of prothioconazole alone results in DON reduction by 40% and that of a Clonostachys strain by about 30%. This effect is observed despite the visual appearance of plants treated with the composition of the invention not being any better than that of plants having received single treatments. It was thus surprising to find out that despite the not improved visual appearance indicating an at least similar infection level by causative fungal species, reduction of a mycotoxin produced by those causative fungal agents could be observed. This observation results in the advantage that even in the case of an infection, harvest may be sold as food or feed because the levels of mycotoxin are reduced.

It is even more preferred that the composition comprises C. rosea f. catenulata strain J1446 and prothioconazole.

The compositions comprising the culture of C. rosea, preferably C. rosea f. catenulata can be in a variety of forms, including, but not limited to, whole cultures, stored stocks of mycelium and/or hyphae (particularly glycerol stocks), agar strips, stored agar plugs in glycerol/water, freeze dried stocks, and dried stocks such as mycelia dried onto filter paper or on or inoculated into live or sterilized grain seeds or conidia. In an embodiment, said C. rosea strain is present in the form of mycelia, spores and/or conidia in a pure or formulated form. In a preferred embodiment, said C. rosea strain is present in the form of spores or conidia. In a more preferred embodiment, said C. rosea strain is present in the form of conidia.

Different methods known in the art may be used for culturing C. rosea, in particular strains of C. rosea f. catenulatum, or preparing fungal spores, including but not limited to the methods described herein and in U.S. Pat. No. 5,968,504 “Fungus Gliocladium catenulatum for biological control of plant diseases”.

Formulation

An isolated culture, fungal spores, mycelium fragments and/or, preferably, conidia from a strain of C. rosea, preferably C. rosea f. catenulatum, may be applied together with a suitable carrier and/or diluent in a composition. The carrier or diluent, which is an agriculturally acceptable carrier or diluent, may be any one or more of a number of carriers that confer a variety of properties, such as increased stability, wettability, dispersability, etc. Suitable carriers may include, but are not limited to, water or other aqueous solutions, slurries, solids (e.g., peat, wheat, bran, vermiculite, pasteurized soil, etc) or dry powders. The composition or formulation may include additional additives including, but not limited to, buffering agents, surfactants, adjuvants, or coating agents. The composition may also comprise, for example, at least one strain of C. rosea, preferably at least one strain of C. rosea f. catenulatum, and a carrier or diluent along with additional biocontrol agent such as an antifungal agent or pesticide. The composition may be a seed treatment formulation, plant treatment formulation, or a soil treatment formulation. The present composition is preferably suited for foliar treatment.

The methods of treatment and uses described herein include contacting a plant or plant material with a composition comprising C. rosea, preferably C. rosea f. catenulatum, and a fungicidally active azole as described above. The composition may be applied to any part of a plant including plant foliage, flowers, roots, tubers and/or seeds (e.g., prior to the seeds being planted to produce a treated plant) by any known method. Suitable methods of treatment may include applying the composition via high or low pressure spraying, misting, dipping, drenching, through nutrient solutions and/or injection depending on the application. Plant seeds may be treated by applying low or high pressure spraying, coating, immersion, and/or injection. After plant seeds have been treated, the seeds may be planted and cultivated to produce plants. Plants propagated from such seeds may be further treated with one or more applications.

Suitable application concentrations may be determined empirically. In some embodiments where the composition comprising C. rosea, preferably C. rosea f. catenulata, is applied as a spray to plants, suitable application concentrations may include spraying about 10⁴-10¹³ colony forming units (cfu) per hectare of plants, about 10⁵ to 10¹² cfu per hectare of plants or about 10⁶ to 10¹¹ cfu per hectare of plants. More particularly, the composition comprising C. rosea f. catenulata is applied to plants at a concentration of about 1×10⁴, about 1×10⁵, about 1×10⁶, about 1×10⁷, about 1×10⁸, about 1×10⁹, about 1×10¹⁰, about 1×10¹¹, about 1×10¹², about 1×10¹³ cfu/ml or greater than 1×10¹³ cfu per hectare of plants.

For coated seeds, in some embodiments, suitable application concentrations may be between 10²-10⁸ cfu per seed, preferably 10⁴-10⁷ cfu per seed.

A skilled person will appreciate that the concentration of cells or spores in the formulation may vary depending on the conditions in which the formulation is to be used (e.g. climate, target plant, method of applying the formulation to the plants or plant materials etc.).

The composition preferably comprises between 0.00000001% and 98% by weight of active ingredient or, with particular preference, between 0.01% and 95% by weight of active ingredient, more preferably between 0.5% and 90% by weight of active ingredient, based on the weight of the composition. The content of the active ingredient is defined as the sum of the fungidically active C. rosea strain and the fungicidally active azole.

The ratio between the fungicidally active azole, such as prothioconazole or epoxiconazole, and said C. rosea strain in the composition of the invention is between about 20:1 and about 1:20, such as 15:1 to 1:15 or 10:1 to 1:10, preferably 5:1 to 1:5. Preferred ranges include between 2:1 and 1:20, such as 2:1 to 1:10 or 1:1 to 1:5, all weight ratios of both active ingredients.

Whereas the composition may in principle be applied to all plants or plant parts infected with Fusarium head blight, cereal plants are a particular target of all aspects of the present invention. A cereal is any grass cultivated for the edible components of its grain, composed of the endosperm, germ, and bran. Besides wheat, rye, rice, barley, oats, millet and triticale the cereals family also comprises maize, rice and fonio.

More preferably, said plant is selected from the group consisting of wheat (Triticum spp.), barley, triticale and maize, more preferably wheat (Triticum spp.), barley and maize.

Most preferably, said plant is wheat, such as Triticum aestivum L. and/or durum wheat T. durum.

It is also considered to be advantageous that the composition according to the invention can be used in particular also for treating transgenic seed or transgenic plants, in particular of a cereal plant, where said plant is capable of expressing a protein which acts against pests. The heterologous gene in transgenic seed can originate, for example, from microorganisms of the species Bacillus, Rhizobium, Pseudomonas, Serratia, Trichoderma, Clavibacter, Glomus or Gliocladium. Preferably, this heterologous gene is from Bacillus sp., the gene product having activity against the European corn borer and/or the Western corn rootworm. Particularly preferably, the heterologous gene originates from Bacillus thuringiensis. By treating such seed or plants with the composition according to the invention, even by the expression of the, for example, insecticidal protein, certain pests may be controlled. Surprisingly, an additional synergistic effect may be observed here, which additionally increases the effectiveness of the protection against attack by pests.

In a further preferred embodiment, the composition further comprises at least one additional/further fungicide, provided that said additional fungicide is not identical to said fungicidally active azole.

Preferably, said at least one additional fungicide is selected from the group consisting of tebuconazole, pydiflumetofen, metconazole, prochloraz and thiophanate-methyl.

In a preferred embodiment, the composition is formulated to additionally comprise at least one auxiliary selected from the group consisting of extenders, solvents, spontaneity promoters, carriers, emulsifiers, dispersants, frost protectants, thickeners and adjuvants. Here, the skilled person is able to determine which auxiliary to choose based on compatibility of such auxiliary in particular with the C. rosea strain of the present composition.

Accordingly, in one aspect of the present invention such formulations, and application forms prepared from them, are provided as crop protection agents and/or pesticidal agents, such as drench, drip and spray liquors, comprising the composition of the invention. The application forms may comprise further crop protection agents and/or pesticidal agents, and/or activity-enhancing adjuvants such as penetrants, examples being vegetable oils such as, for example, rapeseed oil, sunflower oil, mineral oils such as, for example, liquid paraffins, alkyl esters of vegetable fatty acids, such as rapeseed oil or soybean oil methyl esters, or alkanol alkoxylates, and/or spreaders such as, for example, alkylsiloxanes and/or salts, examples being organic or inorganic ammonium or phosphonium salts, examples being ammonium sulphate or diammonium hydrogen phosphate, and/or retention promoters such as dioctyl sulphosuccinate or hydroxypropylguar polymers and/or humectants such as glycerol and/or fertilizers such as ammonium, potassium or phosphorous fertilizers, for example.

Examples of typical formulations include water-soluble liquids (SL), emulsifiable concentrates (EC), emulsions in water (EW), suspension concentrates (SC, SE, FS, OD), water-dispersible granules (WG), granules (GR) and capsule concentrates (CS); these and other possible types of formulation are described, for example, by Crop Life International and in Pesticide Specifications, Manual on development and use of FAO and WHO specifications for pesticides, FAO Plant Production and Protection Papers—173, prepared by the FAO/WHO Joint Meeting on Pesticide Specifications, 2004, ISBN: 9251048576. The formulations may comprise active agrochemical compounds other than one or more active compounds of the invention.

The formulations or application forms in question preferably comprise auxiliaries, such as extenders, solvents, spontaneity promoters, carriers, emulsifiers, dispersants, frost protectants, biocides, thickeners and/or other auxiliaries, such as adjuvants, for example. An adjuvant in this context is a component which enhances the biological effect of the formulation, without the component itself having a biological effect. Examples of adjuvants are agents which promote the retention, spreading, attachment to the leaf surface, or penetration.

These formulations are produced in a known manner, for example by mixing the active compounds with auxiliaries such as, for example, extenders, solvents and/or solid carriers and/or further auxiliaries, such as, for example, surfactants. The formulations are prepared either in suitable plants or else before or during the application.

Suitable for use as auxiliaries are substances which are suitable for imparting to the formulation of the active compound or the application forms prepared from these formulations (such as, e.g., usable crop protection agents, such as spray liquors or seed dressings) particular properties such as certain physical, technical and/or biological properties.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethylformamide and dimethyl sulphoxide, and also water.

In principle it is possible to use all suitable solvents. Suitable solvents are, for example, aromatic hydrocarbons, such as xylene, toluene or alkylnaphthalenes, for example, chlorinated aromatic or aliphatic hydrocarbons, such as chlorobenzene, chloroethylene or methylene chloride, for example, aliphatic hydrocarbons, such as cyclohexane, for example, paraffins, petroleum fractions, mineral and vegetable oils, alcohols, such as methanol, ethanol, isopropanol, butanol or glycol, for example, and also their ethers and esters, ketones such as acetone, methyl ethyl ketone, methyl isobutyl ketone or cyclohexanone, for example, strongly polar solvents, such as dimethyl sulphoxide, and water.

All suitable carriers may in principle be used. Suitable carriers are in particular: for example, ammonium salts and ground natural minerals such as kaolins, clays, talc, chalk, quartz, attapulgite, montmorillonite or diatomaceous earth, and ground synthetic minerals, such as finely divided silica, alumina and natural or synthetic silicates, resins, waxes and/or solid fertilizers. Mixtures of such carriers may likewise be used. Carriers suitable for granules include the following: for example, crushed and fractionated natural minerals such as calcite, marble, pumice, sepiolite, dolomite, and also synthetic granules of inorganic and organic meals, and also granules of organic material such as sawdust, paper, coconut shells, maize cobs and tobacco stalks.

Liquefied gaseous extenders or solvents may also be used. Particularly suitable are those extenders or carriers which at standard temperature and under standard pressure are gaseous, examples being aerosol propellants, such as halogenated hydrocarbons, and also butane, propane, nitrogen and carbon dioxide.

Examples of emulsifiers and/or foam-formers, dispersants or wetting agents having ionic or nonionic properties, or mixtures of these surface-active substances, are salts of polyacrylic acid, salts of lignosulphonic acid, salts of phenolsulphonic acid or naphthalenesulphonic acid, polycondensates of ethylene oxide with fatty alcohols or with fatty acids or with fatty amines, with substituted phenols (preferably alkylphenols or arylphenols), salts of sulphosuccinic esters, taurine derivatives (preferably alkyltaurates), phosphoric esters of polyethoxylated alcohols or phenols, fatty acid esters of polyols, and derivatives of the compounds containing sulphates, sulphonates and phosphates, examples being alkylaryl polyglycol ethers, alkylsulphonates, alkyl sulphates, arylsulphonates, protein hydrolysates, lignin-sulphite waste liquors and methylcellulose. The presence of a surface-active substance is advantageous if one of the active compounds and/or one of the inert carriers is not soluble in water and if application takes place in water.

Further auxiliaries that may be present in the formulations and in the application forms derived from them include colorants such as inorganic pigments, examples being iron oxide, titanium oxide, Prussian Blue, and organic dyes, such as alizarin dyes, azo dyes and metal phthalocyanine dyes, and nutrients and trace nutrients, such as salts of iron, manganese, boron, copper, cobalt, molybdenum and zinc.

Stabilizers, such as low-temperature stabilizers, preservatives, antioxidants, light stabilizers or other agents which improve chemical and/or physical stability may also be present. Additionally present may be foam-formers or defoamers.

Furthermore, the formulations and application forms derived from them may also comprise, as additional auxiliaries, stickers such as carboxymethylcellulose, natural and synthetic polymers in powder, granule or latex form, such as gum arabic, polyvinyl alcohol, polyvinyl acetate, and also natural phospholipids, such as cephalins and lecithins, and synthetic phospholipids. Further possible auxiliaries include mineral and vegetable oils.

There may possibly be further auxiliaries present in the formulations and the application forms derived from them. Examples of such additives include fragrances, protective colloids, binders, adhesives, thickeners, thixotropic substances, penetrants, retention promoters, stabilizers, sequestrants, complexing agents, humectants and spreaders. Generally speaking, the active compounds may be combined with any solid or liquid additive commonly used for formulation purposes.

Suitable retention promoters include all those substances which reduce the dynamic surface tension, such as dioctyl sulphosuccinate, or increase the viscoelasticity, such as hydroxypropylguar polymers, for example.

Suitable penetrants in the present context include all those substances which are typically used in order to enhance the penetration of active agrochemical compounds into plants. Penetrants in this context are defined in that, from the (generally aqueous) application liquor and/or from the spray coating, they are able to penetrate the cuticle of the plant and thereby increase the mobility of the active compounds in the cuticle. This property can be determined using the method described in the literature (Baur et al., 1997, Pesticide Science 51, 131-152). Examples include alcohol alkoxylates such as coconut fatty ethoxylate (10) or isotridecyl ethoxylate (12), fatty acid esters such as rapeseed or soybean oil methyl esters, fatty amine alkoxylates such as tallowamine ethoxylate (15), or ammonium and/or phosphonium salts such as ammonium sulphate or diammonium hydrogen phosphate, for example.

The present invention also relates to a seed coated with the composition described herein above. In addition, the present invention relates to the use of a seed coated with the composition described herein above in agriculture.

Furthermore, the present invention relates to a method of reducing the deoxynivalenol content in cereal grains infected with Fusarium head blight, comprising simultaneously or sequentially applying an effective amount of the composition according to the invention to a cereal plant or seed or a locus where said plant or seed is intended to be grown. In this regard, the term “sequentially applying the composition” means that the individual active ingredients of the composition are applied one after the other.

The skilled person is able to determine the effective amount based on the teaching of the present description further above.

Quantification of deoxynivalenol can be performed by methods well known in the art such as LC-MS/MS analysis, e.g. as done in Example 1.

Cereal plants as well as preferred cereal plants have been described above.

The present invention also relates to a method for reducing other metabolites produced by fungal species causing FHB, such as nivalenol, comprising applying an effective amount of the composition according to the invention to a cereal plant or seed or a locus where said plant or seed is intended to be grown.

The methods of the present invention include the following application methods, namely both of the C. rosea strain and the fungicidally active azole mentioned before may be formulated into a single, stable composition with an agriculturally acceptable shelf life (so called “solo-formulation”), or being combined before or at the time of use (so called “combined-formulations”).

If not mentioned otherwise, the expression “composition” stands for the various combinations of the C. rosea strain and the fungicidally active azole, and optionally at least one additional fungicide, in a solo-formulation, in a single “ready-mix” form or in a combined spray mixture composed from solo-formulations, such as a “tank-mix”, and especially in a combined use of the single active ingredients when applied in a sequential manner, i.e. one after the other within a reasonably short period, such as a few hours or days, e.g. 2 hours to 20 days, preferably 15 days. The order of applying the composition according to the present invention is not essential for working the present invention. Accordingly, the term “combination” also encompasses the presence of the at least one biological control agent and the at least fungicidally active azole, and optionally the at least one further fungicide on or in a plant to be treated or its surrounding, habitat, locus where it is intended to be grown or storage space, e.g. after simultaneously or consecutively applying the at least one biological control agent and the at least one fungicidally active azole, and optionally the at least one further fungicide to a plant, its surrounding, habitat, locus where it is intended to be grown or storage space.

In a preferred embodiment of the methods of the invention, said simultaneous application is effected between growth stages 61 and 69.

In another preferred embodiment of a sequential application in the methods of the invention, application of said azole is effected between growth stages 39 to 59, preferably between growth stages 51 and 59, more preferably between growth stages 51 and 55, and application of said C. rosea strain is effected between growth stages 61 and 69, preferably between growth stages 61 and 65. For example, application of said azole is effected between growth stages 51 and 59, preferably between growth stages 51 and 55, and application of said C. rosea strain is effected between growth stages 61 and 65.

Several development scales for crop plants exist. For cereals, the most widely used one is the decimal Zadoks scale (J. C. Zadoks, T. T. Chang, C. F. Konzak, “A Decimal Code for the Growth Stages of Cereals”, Weed Research 1974 14:415-421) dividing cereal development into 92 stages. In order to most efficiently reduce the content of DON and/or its metabolite(s) and/or other mycotoxins such as nivalenol, 15-Ac-DON and 3-Ac-DON, the present composition is applied between Zadoks stage 61 and 69.

The development scale for crops other than cereals is the BBCH-scale, which is adapted according to crop/plant and in its structure based on the Zadoks scale. It can be reviewed in the monograph “Growth stages of mono- and dicotyledonous plants” (edited by Uwe Meier, Federal Biological Research Centre for Agriculture and Forestry, Germany), retrievable under http://www.jki.bund.de/fileadmin/dam_uploads/_veroeff/bbch/BBCH-Skala_englisch.pdf (last checked 21 Apr. 2016)

In another aspect of the methods of the present invention, application of the composition according to the invention in a simultaneous or sequential manner as described above is preceded by an application of further plant protection agent. Suitable plant protection agents comprise insecticides, and fungicides such as chlorothalonil.

Usually, the C. rosea strain to be employed or used according to the invention is present in about 2% to about 80% (w/w), preferably in about 5% to about 75% (w/w), more preferably about 10% to about 70% (w/w) of its solo-formulation or combined-formulation with the at least one fungicide.

Also the amount of the at least one fungicidally active azole which is used or employed in combination with the C. rosea strain, optionally in the presence of at least one additional fungicide, depends on the final formulation as well as size or type of the plant, plant parts or seeds to be treated. Usually, the fungicidally active azole to be employed or used according to the invention is present in about 0.1% to about 80% (w/w), preferably 1% to about 60% (w/w), more preferably about 10% to about 50% (w/w) of its solo-formulation or combined-formulation with the C. rosea strain.

The cell/spore concentration of preparations can be determined by applying methods known in the art. To compare weight ratios of C. rosea preparation to the fungicidally active azole, the skilled person can easily determine the factor between a preparation having a biological control agent/spore concentration different from 10¹⁰ cells/spores per gram cell/spore preparation and a preparation having a biological control agent/spore concentration of 10¹⁰ cells/spores per gram preparation to calculate whether a ratio of a biological control agent/spore preparation to the fungicide is within the scope of the above listed ratio ranges.

In one embodiment of the present invention, the concentration of the biological control agent after dispersal is at least 50 g/ha, such as 50-7500 g/ha, 50-2500 g/ha, 50-1500 g/ha; at least 250 g/ha (hectare), at least 500 g/ha or at least 800 g/ha.

The application rate of composition to be employed or used according to the present invention may vary. The skilled person is able to find the appropriate application rate by way of routine experiments.

The present invention further relates to the use of the composition described herein above as a fungicide.

In another aspect, the present invention relates to the use of the composition described herein above for reducing the deoxynivalenol or nivalenol content in cereal grains.

The invention finally relates to a kit of parts comprising a fungicidally active C. rosea strain and prothioconazole as described herein above.

In a further embodiment of the present invention the above-mentioned kit of parts further comprises at least one additional fungicide, with the proviso that said fungicidally active azole is not identical to said additional fungicide. Moreover, the kit of parts according to the present invention can additionally comprise at least one auxiliary selected from the group consisting of extenders, solvents, spontaneity promoters, carriers, emulsifiers, dispersants, frost protectants, thickeners and adjuvants as mentioned below. This at least one auxiliary can be present either in the biological control agent component of the kit of parts or in the fungicide component of the kit of parts being spatially separated or in both of these components.

The examples illustrate the present invention in a non-limiting fashion.

### EXAMPLE 1

### Impact of Different Compounds on Fusarium Infestation and the DON Content; Field Trial Winter Wheat 2017 at the Laacherhof, Germany

Application was done on Jun. 1, 2017 at growth stage 63-65. Evaluation was done Jun. 20, 2017. Quantification of deoxynivalenol was performed by LC-MS/MS analysis using a Waters UPLC coupled to a Sciex API4000 mass spectrometer. The column used was a Waters Acquity HSS T3 (2.1×50 mm, 1.8 μm) and solvents were 2 mM ammonium acetate/1% acedic acid and methanol/2 mM ammonium acetate/1% acetic acid used in a 4 min gradient. The mass spectrometer was operated in negative ionization mode (MRM transitions: deoxynivalenol 355>265, 3-acetyl-deoxynivalenol 387>307, respectively). Quantification was performed by external calibration using reference compounds.

As can be seen from the table below, whereas the rate of infestation was similar for application of prothioconazole and the combination of C. f. catenulatum rosea strain J1446 and prothioconazole (66 and 63%, respectively), DON reduction was much greater (60 vs. 41%). On the other hand, whereas infestation was lower upon application of C. rosea J1446 alone (45 vs. 63%), DON reduction after application of the combination of prothioconazole and C. rosea J1446 was even bigger (60 vs. 30%).

| | | Visual Assessment | |
|---|---|---|---|
| | Use Rate | Fusarium-Control | DON Reduction |
| Treatment | (g/ha) | (%) | (%) |
| Control | — | (38% infestation) | (3583 ppb |
| | | | DON content) |
| Clonostachys roseae | 500 | 45 | 30 |
| strain J1446 | | | |
| Prothioconazole | 125 a.i. | 66 | 41 |
| Clonostachys roseae | 500 + 125 | 63 | 60 |
| strain J1446 + | a.i. | | |
| Prothioconazole | | | |

1. A composition comprising a fungicidally active C. rosea f. catenulata strain and a fungicidally active azole.

2. The composition according to claim 1, wherein the azole is prothioconazole or epoxiconazole.

3. The composition according to claim 1, wherein said fungicidally active C. rosea f. catenulata strain is active against Fusarium head blight.

4. The composition according to claim 1, wherein said C. rosea f. catenulata strain is C. rosea f. catenulatum J1446 deposited under accession number DSM 9212.

5. The composition according to claim 1, wherein said C. rosea f. catenulata strain is present in the form of spores, mycelia or conidia.

6. The composition according to claim 1, wherein the ratio between said C. rosea f. catenulata strain and said fungicidally active azole is between about 20:1 and about 1:20.

7. The composition according to claim 1, further comprising at least one additional fungicide provided that said additional fungicide is not identical to said fungicidally active azole.

8. The composition according to claim 7, wherein said at least one additional fungicide is selected from the group consisting of tebuconazole, pydiflumetofen, metconazole, prochloraz and thiophanate-methyl.

9. The composition according to claim 1 additionally comprising at least one auxiliary selected from the group consisting of extenders, solvents, spontaneity promoters, carriers, emulsifiers, dispersants, frost protectants, thickeners and adjuvants.

10. A seed coated with the composition according to claim 1.

11. A method of reducing the deoxynivalenol content in cereal grains infected with Fusarium head blight, comprising simultaneously or sequentially applying an effective amount of the composition according to claim 1 to a cereal plant or seed or a locus where said plant or seed is intended to be grown.

12. The method according to claim 11, wherein said simultaneous application is effected between growth stages 61 and 69.

13. The method according to claim 11, wherein in a sequential application, application of said azole is effected between growth stages 51 and 55 and application of said C. rosea strain is effected between growth stages 61 and 69.

14. The method according to claim 11, wherein the cereal is spring wheat or winter wheat.

15-16. (canceled)

17. A kit of parts comprising a fungicidally active C. rosea strain and prothioconazole as described in claim 1.
